(19) United States
(12) Patent Application Publication
(10) Pub. No.: US 2006/0291146 A1
(43) Pub. Date: Dec. 28, 2006

(54) Packaging container for permanent magnets

(76) Inventor: Scott Everett Madsen, Falls Church, VA (US)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/407,975

(22) Filed: Apr. 21, 2006

Related U.S. Application Data
(60) Provisional application No. 60/693,708, filed on Jun. 24, 2005.

(51) Int. Cl. H02B 1/00

(52) U.S. Cl. 361/600

(57) ABSTRACT

A transparent plastic tube packaging container includes an outer tube having an inner tube of smaller diameter mounted therein to form a space or air gap on all sides between the inner tube and the outer tube. A first end plug closes a bottom of the inner tube and is fitted within the outer tube adjacent the bottom thereof and a second plug closes a top of the inner tube and is fitted within the outer tube adjacent the top of the tube. Hubs extending inwardly from the end plugs hold magnets placed in the inner tube in a position spaced from the top and the bottom of the inner tube.

### BACKGROUND OF THE INVENTION

1. Field of the Invention

The present invention relates to a packaging container for permanent magnets and, more particularly, to a transparent plastic tube packaging container for permanent magnets.

2. Description of the Related Art

As permanent magnets which are being used today become stronger and achieve greater flux densities, problems in packaging, handling, storage and transporting become more prevalent. The latest generation of permanent magnets such as samarium-cobalt and neodymium-iron-boron magnets achieve flux densities many times greater than prior compositions of permanent magnets such as ceramic and alnico. Additionally, because many present day magnetic materials are brittle, they are easily damaged through impact. It is therefore important that the present day permanent magnets be packaged carefully.

Many existing types of packaging containers for magnets do not provide any method to reduce the flux density present on the surface of the package. Some rely on wrapping the magnets in a material such as paper or foam to isolate the magnets. Some rely on ferromagnetic material such as steel that is used to shield the magnet by channeling the magnetic flux from one magnet pole to the other. An example of such a package is steel plated boxes made of sheet steel 1/16^{th} of an inch thick. Others arrange magnets with dissimilar poles together, creating a magnetic circuit and a path for flux.

These existing types of packaging for magnets have certain disadvantages such as allowing the magnets to snap together and cause damage to the magnets, allowing the magnets to impact ferromagnetic material causing damage to the material, allowing the magnets to impact ferromagnetic material causing damage to the magnets, allowing the magnets within the package to come close enough to one another that they adhere to one another through the packaging, allowing the magnets to adhere to storage and transportation equipment such as warehouse bins, conveying systems and vehicles, and allowing the magnets to damage magnetic media and electronic equipment by coming in close proximity with these items. Further disadvantages may include preventing an order processing individual or a customer in a retail environment from separating the packaged magnets easily, preventing the customer from seeing the magnets if wrapped in a protective material such as paper or packing foam and being more expensive through the use of expensive and heavy magnetic shielding that channels the magnetic flux closer to the magnet.

### SUMMARY OF THE INVENTION

It is an object of the present invention to provide a packaging container for permanent magnets which avoids the disadvantages of the prior art discussed above by providing a transparent plastic tube packaging container for permanent magnets which can be easily seen through and which significantly reduces the flux density at the surface of the package because of the isolation of the magnets from the surface of the package.

A further object of the invention is to provide a packaging container for permanent magnets that is more easily handled when it is in the presence of other magnets or ferromagnetic material because of the isolation of the magnets from the surface of the package.

It is another object of the invention to provide a packaging container for permanent magnets that provides a protective enclosure for the magnets because of the rigidity of the enclosure and the isolation of the magnets from the surface, that is transparent so that it allows the contents to be viewed by an individual such as a retail customer and that can be hung on a retail display because of a hang tab mounted to one end of the package.

The present invention achieves the above and other objects by providing a transparent plastic tube packaging container for permanent magnets which includes an outer tube and an inner tube mounted in a fixed position within the outer tube and spaced therefrom on all sides to form a gap between the inner tube and the outer tube. A bottom wall is provided closing the bottom of the outer tube. A first end plug is provided for closing a bottom of the inner tube and is fitted within the outer tube adjacent the bottom of the outer tube. A second end plug is provided for closing a top of the inner tube and is fitted within the outer tube adjacent a top of the outer tube. Means are also provided within the inner tube for holding therein one or more permanent magnets in a position spaced from the top and the bottom of the inner container. The means within the inner tube includes a first hub extending inwardly from an inner surface of the first end plug and a second tube extending inwardly from an inner surface of the second plug. A top end plug is provided for closing the top of the outer tube. A hang tab may be connected to the outer surface of the top end plug so that the packaging container may be hung from a support.

These and other features and advantages of the present invention will be become more apparent with the following detailed description and drawings.

### BRIEF DESCRIPTION OF THE DRAWINGS

FIG. 1 is an exploded, isometric view showing the individual parts of the packaging container of the present invention;

FIG. 2 is a side perspective view of the container; and

FIG. 3 is a sectional view of four units of the packaging container placed adjacent one another as in a storage or shipping container.

### DETAILED DESCRPTION OF THE PREFERRED EMBODIMENTS

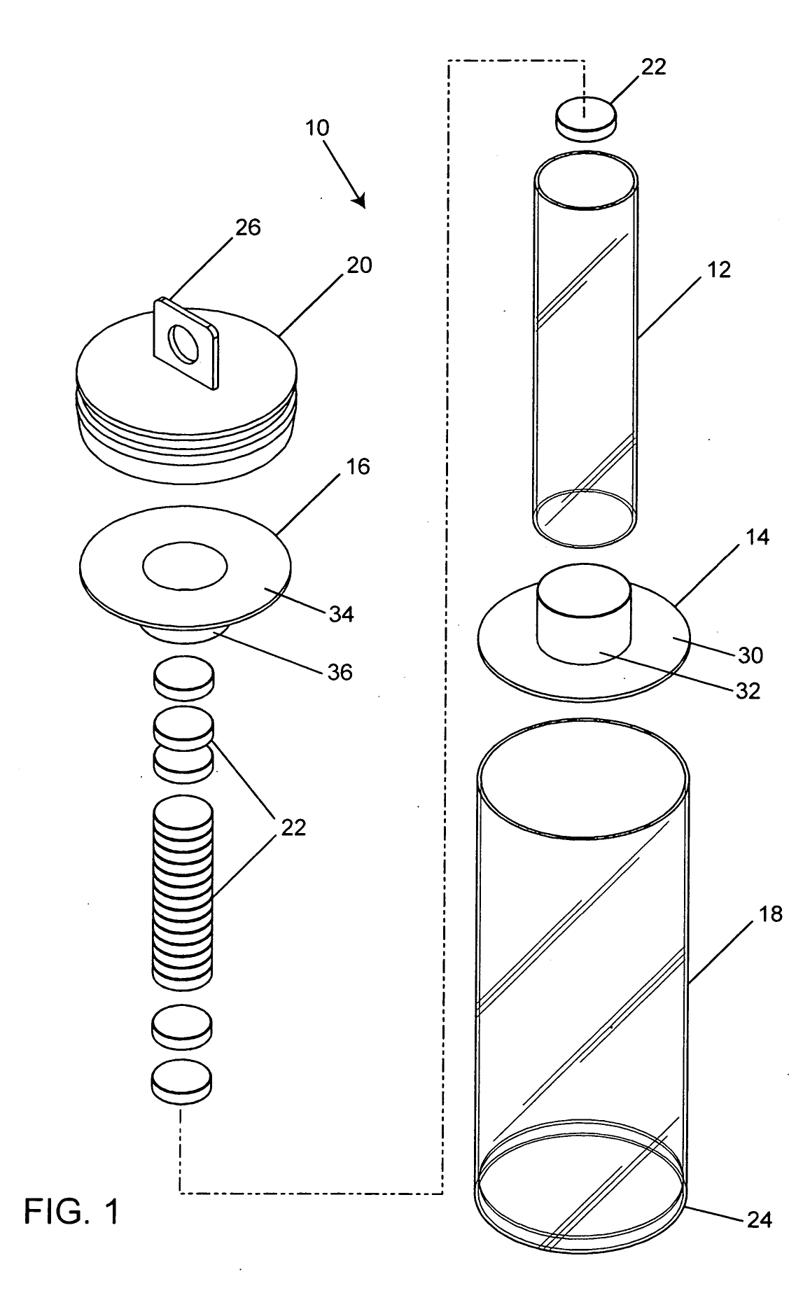

As shown in FIGS. 1 and 3, the packaging container 10 of the present invention for holding permanent magnets includes a transparent inner, semi-rigid plastic tube 12 open on each end and which may be constructed of glycol-modified polyethylene terephthalate. An inner semi-rigid plastic first end plug and centering device 14 is provided that seals and centers the inner transparent plastic tube bottom opening. Another inner semi-rigid second end plug and centering device 16 seals and centers the inner transparent plastic tube top opening. Both the first end plug and second end plug may be constructed of a low density polyethylene.

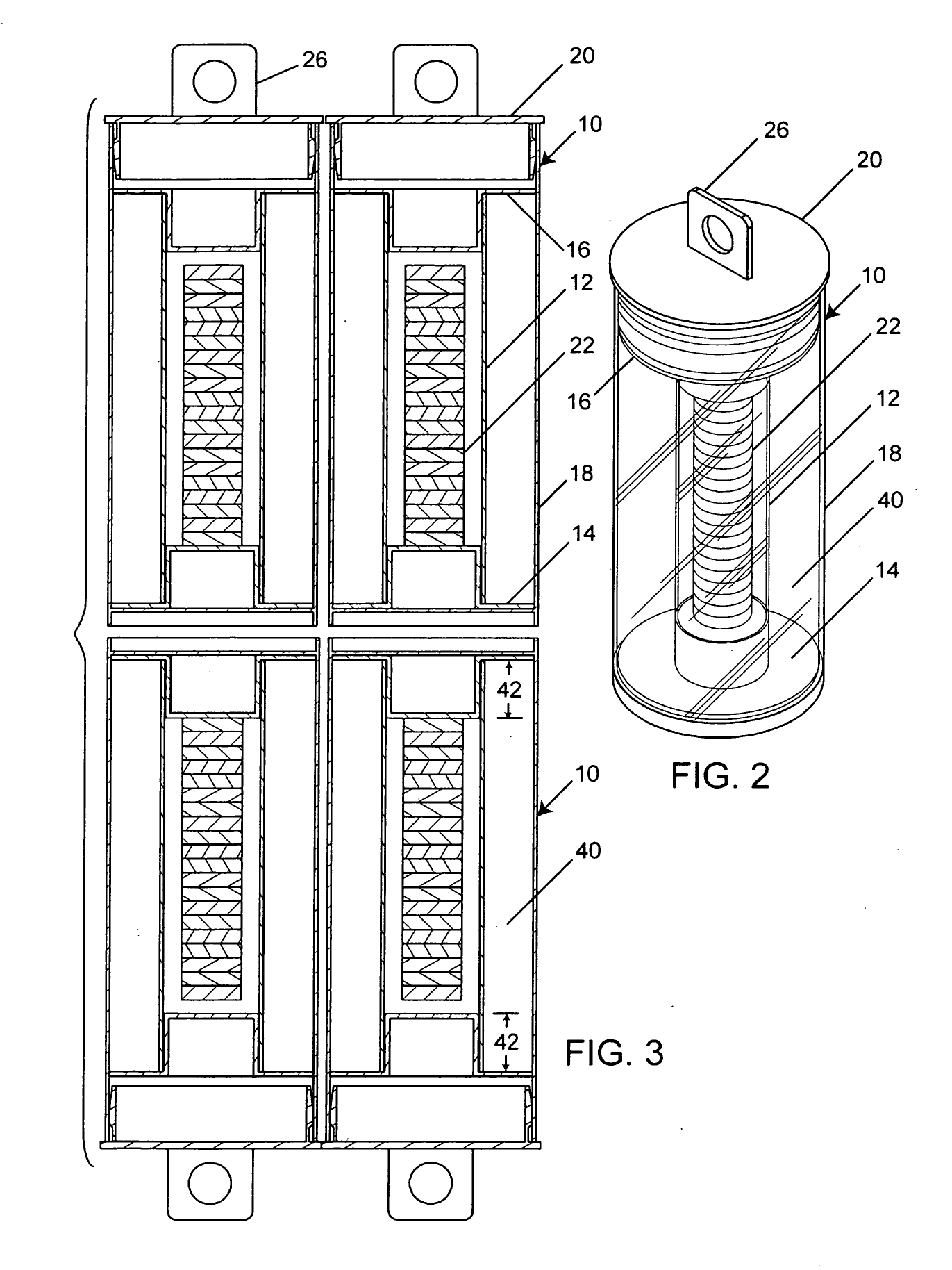

The inner tube 12 and the first end plug 14 are positioned within an outer tube 18 having a sealed bottom 24 and being open at the top. The outer tube 18 maybe constructed of a transparent semi-rigid plastic such as glycol-modified polyethylene terephthalate. A top end plug 20 constructed of a semi-rigid plastic such as a low density polyethylene is provided for closing the top of the outer tube 18. The top end plug may be provided with a hang tab 26 to hang the packaging container on a suitable support such as a hook. The top end plug may be provided with ridges around the outer circumference thereof to form a friction fit with the top of the outer tube 12 to secure the end plug to the packaging container. Alternatively, the end plug and the top of the outer tube 18 may be provided with threads so that the end plug may be screwed into the upper end of the outer tube. As shown in FIGS. 2 and 3, permanent magnets 22 are positioned within the interior of the inner tube 12. Either a single magnet or a plurality of magnets 22 may be placed in the inner tube 12.

The first end plug 14 for closing the bottom of inner tube 12 is comprised of a flat circular flange portion 30 having a hub 32 extending upwardly and inwardly from the inner surface of the flange. The flange 30 has a diameter slightly smaller than the inner diameter of the outer tube 18 to allow it to slide downwardly into the outer tube 18. The hub 32 has a diameter slightly smaller than the inner diameter of the inner tube 12 and is tapered whereby the hub fits into the bottom of the inner tube 12 with a friction fit to maintain it in place. The second end plug 16 for the top of the inner tube 12 has a construction identical to that of the first end plug 14 in that it has a circular flange 34 having a hub 36 extending inwardly from an inner surface of the second end plug 16. The hub portion 36 has a diameter slightly smaller than the inner diameter of the upper end of the inner tube 12 and is tapered so that the second end plug 16 is maintained in place by a friction fit with the top of the inner tube 12.

As shown in FIGS. 2 and 3 of the drawings, the outer tube 18 has a substantially larger diameter than the inner tube 12 to thereby create an enclosed space or air gap 40 between the inner and the outer tube.

Magnets inherently exert an attractive force on other magnets and ferromagnetic material such as steel, iron, nickel and cobalt. This force decreases exponentially with distance. A magnet that is one inch from a piece of steel may exert 10 ounces of attractive force on the steel. If the magnet is moved an additional inch away from the steel, the magnet may only exert one ounce of attractive force on the steel. Creating a fixed amount of space such as that shown by 40, between a magnet and ferromagnetic or other magnetic objects will reduce the amount of force a magnet can exert on these objects. Accordingly, the packaging container of the present invention incorporates the fixed amount of space 40 between the magnet and the outside of the packaging so that it can significantly reduce the attractive force of the magnets contained within the packaging container. The fixed space is also known as an air gap.

The present invention creates this fixed amount of space 40 by centering the inner transparent tube 12 holding the magnets 22 inside a larger outer tube 18 by using the end plugs 14 and 16 with large diameter flanges as the centering devices. In the preferred embodiment of the packaging container of the present invention, the magnet or a set of magnets 22 are placed in the transparent inner tube 12 and centered within the transparent outer tube 18 by the two end plugs 14 and 16 having the hubs 32 and 36.

Thus, the first and second end plugs 14 and 16 perform several functions. They secure the magnets within the inner tube and provide a fixed amount of space or an air gap 42 on each end of the inner tube as shown in FIG. 3. The end plugs also center the inner tube 12 within the outer tube 18, which provides a fixed amount of space or air gap around the entire circumference of the inner tube. The rigidity of the flanges 30 and 34 on the first and second end plugs 14 and 16 prevents the magnets from moving toward the inner surface of the outer tube. Moreover, the inner and outer tubes are transparent which allows a viewing of the contents or magnets 22 inside the inner tube.

Once the inner tube 12, end plugs and centering devices 14 and 16 and magnets 22 are assembled as previously described and placed into the outer tube 18 and the top end plug 20 is put in place, the completed assembly passively isolates the magnets from other magnets, ferromagnetic material, electronic equipment and the like outside of the packaging container. In this manner, the assembled packaging container provides a container that significantly reduces the flux density at the surface of the package because of the isolation of the magnets from the surface. Moreover, the assembled packaging container provides a container that is more easily handled when it is in the presence of other magnets or ferromagnetic material because of the isolation of the magnets from the outer surface of the outer tube. The packaging container further provides a protective enclosure for the magnets because of the rigidity of the container and the isolation of the magnets from the surface of the outer tube, provides a container which is transparent so that the contents may be viewed and provides a container that can be hung on a retail display because of the hang tab 26 on the top end plug 20.

Illustrated in FIG. 3 is a sectional view of four assembled containers in a storage orientation. This view shows the fixed amount of space or air gap between the magnets within each container. This fixed space significantly reduces the attractive forces between the containers, allowing an individual to easily separate the containers. This type of orientation will also be applicable in a retail environment where the assembled container would be hung on a retail hook or placed next to each other on a shelving unit.

The present invention also encompasses other alternative embodiments. Thus, the tubing and plugs could be made of alternative materials such as other plastics, paper, metal and glass. The tubing plugs could be made as a single piece, plugging the ends of the inner and outer tubes at the same time. The closed end of the outer tube could be replaced with an open end tube and an end plug could be used instead of a sealed end. The tubing and plugs could be altered to make the package into other shapes such as elliptical. Moreover, the hang tab could be removed for applications that do not require the ability to hang the packaging containers.

Numerous other modifications and adaptations of the present invention will be apparent to those skilled in the art and thus, it is intended by the following claims to cover all such modifications and adaptations which fall within the true spirit and scope of the invention.

I claim:

1. A packaging container for permanent magnets comprising:
a) an outer container;
b) an inner container positioned with said outer container;
c) means for holding said inner container in a fixed position within said outer container whereby said inner container is spaced from an inner surface of said outer container on all sides to form a gap between said inner container and said outer container; and
d) means within said inner container for holding therein one or more permanent magnets in a position spaced from a top and a bottom of said inner container.

2. A packaging container for permanent magnets according to claim 1 wherein said outer container is comprised of an outer tube and said inner container is comprised of an inner tube having a smaller diameter than said outer tube.

3. A packaging container for permanent magnets according to claim 2 wherein said outer tube and said inner tube are constructed of a transparent material.

4. A packaging container for permanent magnets according to claim 3 wherein said transparent material is a plastic material.

5. A packaging container for permanent magnets according to claim 2 wherein said outer tube and said inner tube are constructed of a transparent plastic material and the packaging container further comprises:
a) a bottom wall connected to and closing a bottom of said outer tube;
b) a first end plug closing a bottom of said inner tube and fitted within said outer tube adjacent the bottom of said outer tube;
c) a second end plug closing a top of said inner tube and fitted within said outer tube adjacent the top of said outer tube; and
d) a top end plug closing a top of said outer tube.

6. A packaging container for permanent magnets according to claim 5 which further comprises a hang tab connected to an outer surface of said top end plug.

7. A packaging container for permanent magnets according to claim 5 wherein said means within said inner container for holding therein at least one permanent magnet comprises a first hub extending inwardly from an inner surface of said first end plug and a second hub extending inwardly from an inner surface of said second end plug.

8. A packaging container for permanent magnets comprising:
a) an outer tube;
b) an inner tube mounted in a fixed position within said outer tube and spaced therefrom on all sides to form a gap between said inner tube and said outer tube;
c) a bottom wall connected to and closing a bottom of said outer tube;
d) a first end plug closing a bottom of said inner tube and fitted within said outer tube adjacent the bottom of said outer tube;
e) a second end plug closing a bottom of said inner tube and fitted within said outer tube adjacent a top of said outer tube;
f) means within said inner tube for holding therein one or more permanent magnets in a position spaced from the top and the bottom of said inner tube, said means within said inner tube comprising a first hub extending inwardly from an inner surface of said first end plug and a second hub extending inwardly from an inner surface of said second plug; and
g) a top end plug closing the top of said outer tube.

9. A packaging container for permanent magnets according to claim 8 wherein said outer tube and said inner tube are constructed of a transparent material.

10. A packaging container for permanent magnets according to claim 9 wherein said transparent material is a plastic material.

11. A packaging container for permanent magnets according to claim 8 which further comprises a hang tab connected to an outer surface of said top end plug.
